(19) United States
(12) Patent Application Publication
(10) Pub. No.: US 2024/0307996 A1
(43) Pub. Date: Sep. 19, 2024

(54) CONTROL METHOD AND CONTROL DEVICE FOR A LASER PROCESSING MACHINE

(71) Applicant: TRUMPF Laser GmbH, Schramberg (DE)

(72) Inventors: Rainer Flaig, Eschbronn (DE); Juergen Vogel, Brigachtal (DE); Michael Kraus, Hardt (DE); Martin Stambke, Dunningen (DE); Martin Keller, Schramberg (DE); Ralf Bartmuss, Dietingen (DE); Thomas Notheis, Schramberg (DE); Jan-Patrick Hermani, Markgroeningen (DE)

(21) Appl. No.: 18/674,985

(22) Filed: May 27, 2024

Related U.S. Application Data
(63) Continuation of application No. PCT/EP2022/082257, filed on Nov. 17, 2022.

(30) Foreign Application Priority Data
Dec. 6, 2021 (DE) 102021132005.4

(51) Int. Cl. B23K 26/03

(52) U.S. Cl. CPC B23K 26/03

(57) ABSTRACT

A method for controlling a laser processing machine includes providing the laser processing machine. The laser processing machine includes a laser source, a process optical unit, and a control device. The method further includes creating redundant data of the laser source and of the process optical unit, transferring the redundant data of the laser source and of the process optical unit to the control device by data streaming, and comparing the redundant data of the laser source and of the process optical unit.

### CROSS REFERENCE TO RELATED APPLICATIONS

This application is a continuation of International Application No. PCT/EP2022/082257 (WO 2023104465 A1), filed on Nov. 17, 2022, and claims benefit to German Patent Application No. DE 10 2021 132 005.4, filed on Dec. 6, 2021. The aforementioned applications are hereby incorporated by reference herein.

### FIELD

Embodiments of the present invention relate to a control method for a laser processing machine, to a laser processing machine and to a computer program product.

### BACKGROUND

Laser-based workpiece processing is gaining traction in the commercial sphere. Especially noteworthy in this context are the welding and cutting of workpieces, for instance the precise welding of battery cells for electric drives or of fuel cells. Battery cell welding is a critical process, also in view of safety requirements. A multitude of data is processed for the control and process monitoring of a laser processing machine for laser welding, for instance the power of a laser source and the spatial position of a process optical unit, for instance a laser scanner. The individual components of the laser processing machine comprising means for laser welding and means for monitoring the laser welding are controlled by respective control devices.

Certain laser welding processes, for instance the aforementioned battery welding or welding of fuel cells, place increased demands on safety.

### SUMMARY

Embodiments of the present invention provide a method for controlling a laser processing machine. The method includes providing the laser processing machine. The laser processing machine includes a laser source, a process optical unit, and a control device. The method further includes creating redundant data of the laser source and of the process optical unit, transferring the redundant data of the laser source and of the process optical unit to the control device by data streaming, and comparing the redundant data of the laser source and of the process optical unit.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an exemplary schematic view of a laser processing machine having a laser source, a control device, a robot for displacing a processing head with a process optical unit and a machine for transporting a workpiece to be processed, and data streaming to and from the control device, according to some embodiments.

### DETAILED DESCRIPTION

Embodiments of the present invention provide a control method for a laser processing machine, a laser processing machine and a computer program product which meet high safety demands. Embodiments of the present invention also provide a control method for a laser processing machine, a laser processing machine and a computer program product which enable comprehensive recording of relevant process variables of the laser processing machine during operation.

According to embodiments of the invention, a control method for a laser processing machine, including the following method steps:
providing a laser processing machine comprising a laser source, a process optical unit and a control device of the laser processing machine;
creating redundant data of the laser source and of the process optical unit;
transferring the redundant data of the laser source and of the process optical unit to the control device by way of data streaming;
comparing the redundant data.

A computer program product for carrying out the method is also provided.

According to embodiments of the present invention, a laser processing machine comprising a laser source, a process optical unit and a control device, wherein the laser processing machine is designed to transfer redundant data of the laser source and of the process optical unit to the control device by means of data streaming and the control device is designed to receive, by means of data streaming, and compare the redundant data.

In an example, the redundant data are compared or checked with regard to identity, plausibility and/or integrity. This determines with high probability whether the data are correct or whether they have errors, with data errors possibly putting at risk the safe operation of the laser processing machine.

In an example, the data streaming is implemented via optical fibre connections and hence enables reliable and quick transfer of critical data to the control device. Further, data streaming can be implemented via electric line connections or wireless connections, conventional radio connections by means of modulated electromagnetic waves. This enables a cost-effective and standardizable data transfer.

In a further example, the redundant data with regard to the laser power of the laser source, the process optical unit and/or the thermal profile at a workpiece to be processed, of a camera device, an OCT device and/or a spectrometer are created and transferred to the control device.

In a further example, redundant data with regard to the position of a robot for displacing the process optical unit and the position of a workpiece at the laser processing machine are created and transferred. The workpiece is usually transported by a transportation device or machine. During operation, the robot is installed in the proximity of the machine in order to ensure an alignment of the process optical unit with respect to the workpiece. The robot and the machine may be comprised by the laser processing machine. The redundant data made available thus were found to be relevant to the operational safety of the laser processing machine and, in particular, to the safe execution of the processes when processing using laser radiation.

In a further example, a safety shutdown of the laser source is triggered if the comparison of the redundant data does not yield identity of the redundant data or if the compared redundant data exceed an error threshold. It was established that the operational safety of the processes of a laser processing machine can be significantly increased by way of the above-described features of the control device.

In a further example, the laser processing machine comprises a data stream management system (DSMS). This simplifies management of the large amounts of arising data and allows standardization.

In an embodiment, the redundant data are recorded and stored, with the stored redundant data being assigned to workpieces processed by means of the laser processing machine. As a result, the received redundant data are available for each processed workpiece and can be retrieved in subsequent processing procedures. Hence, quality data storage can be performed with the redundant data.

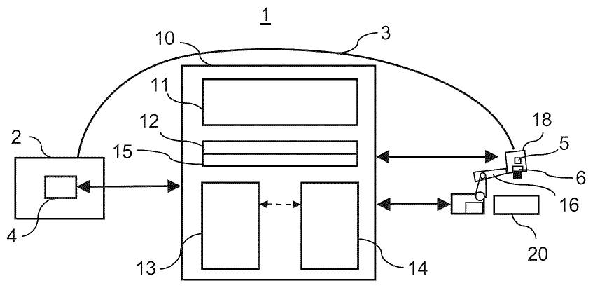

FIG. 1 shows an exemplary schematic view of a laser processing machine 1 for processing workpieces, usually for welding or cutting workpieces made of different materials. In this example, the workpiece is a battery cell or a fuel cell. The proportions in FIG. 1 do not correspond to the actual proportions but have been chosen for illustrative reasons. The laser processing machine 1 comprises a laser source 2 which, under the control of a laser controller 4, creates and transmits laser radiation. In this example, the laser radiation is coupled at low power into a laser light cable 3 and supplied to a laser scanner which serves in this example as a process optical unit 5 for optically monitoring the result of the laser processing. Laser processing of the workpiece is performed at a higher power of the laser source 2, said power being supplied via the laser light cable 3 to a cutting nozzle or welding nozzle in a processing head 18. The process optical unit 5 is arranged in the machining head 18 which is attached to an industrial robot or robot 16 in this example and is controllably moved by the latter. For example, the process optical unit 5 is designed as a laser scanner. The robot 16 consists of a housing with a controller and an arrangement of robotic arms which are controllably movable and connected to one another. In this way, the processing head 18 can be freely movable and aligned, and the laser radiation from the laser scanner or the cutting or welding nozzle can be supplied to different positions. A camera device 6 recording camera images of the workpiece, in particular of an interaction region of the laser beam on the workpiece, for instance a welding seam, is arranged in the processing head 18. In an alternative or in addition, an OCT device and/or a spectrometer may be arranged in the processing head 18.

The low-power laser radiation is supplied by the laser scanner to a workpiece to be processed, the latter being transported on a transport machine or machine 20 comprised by the laser processing machine 1. The machine 20 is arranged in the proximity of the robot 16 such that the laser radiation from the processing head 18 can be incident on the workpiece on the machine 20. The laser processing machine I also comprises at least one control device 10, which carries out different control functions. The control device 10 is connected to the laser source 2, to the robot 16, to the processing head 18 and to the machine 20 via data lines. The data lines are optical fibre connections, which ensure fast data transport, or wireless radio connections. The data transport of the data is implemented by means of data streaming, wherein a continuous flow of data records is transferred and processed directly in real time or virtually in real time. In this example, the control device 10 comprises at least one processor unit 11, which processes data from the laser source 2, the processing head 18, the robot 16 and from the machine 20. The redundant data are processed or evaluated in the control device 10, i.e. data assessed by means of image processing software are created from the raw data of cameras, for instance, which supply redundant data, and are used to derive, for instance, temperature curves on the workpiece or the alignment of the workpiece in the machine 20.

Then, data with regard to the laser power of the laser source 2, data recorded by the process optical unit 5, position data of the process optical unit 5, of the thermal profile on the workpiece to be processed, with regard to the position of the robot 16 for displacing the laser scanner, of the position of the workpiece and of further process variables are available in the control device 10. For instance, data recorded by the process optical unit 5 are scan data of features of a weld seam, dimensions and depth of the weld seam, or scan data of cutting edges. The process optical unit 5 can be designed as a scanner which is designed with means for optical coherence tomography (OCT) and creates OCT data in this case. The control device 10 also comprises a data stream management system (DSMS) which facilitates the processing of the incoming data records from the data streaming. Data of at least one of the aforementioned process variables are created redundantly; the data are acquired independently of one another by different pieces of measuring equipment or sensors. For example, the laser power of the laser source 2 is measured independently of one another by two pieces of measuring equipment. Further, the control device 10 comprises a process logging unit 12 for creating logs of the connected components in real time and a user interface 15 for the process visualization of processes of the laser processing machine 1 during operation. The process logging unit 12 and the user interface 15 can also be present integrated in one device. Further, the control device 10 comprises a first monitoring unit 13 and a second monitoring unit 14, to which the redundant data are supplied. The aforementioned data of the laser processing machine 1 are thus available as redundant data, acquired independently of one another during operation, in the first monitoring unit 13 and in the second monitoring unit 14. The redundant data are assessed in the control device 10, i.e.:

The respective redundant data and the evaluated or assessed data from the redundant data in the first monitoring unit 13 and in the second monitoring unit 14 are compared to one another. In FIG. 1, this data comparison is represented by a dashed double-headed arrow. For example, the laser power of the laser source 2 as acquired by a piece of measuring equipment and supplied to the first monitoring unit 14 by means of data streaming is compared with the laser power of the laser source 2 as acquired by a different piece of measuring equipment and supplied to the second monitoring unit 14 by means of data streaming. Redundant data of other process variables are compared accordingly. Malfunctions in the process sequence of the laser processing machine 1 can be discovered reliably and quickly within the scope of the comparison or cross check of the redundant data or the evaluated or assessed redundant data in the control device 10. It is established that a piece of measuring equipment or a sensor possibly creates incorrect data for various reasons, wherein the safe operation of the laser processing machine 1 might no longer be ensured. Error thresholds on the basis of the data comparison, the overshoot of which leads to the identification of an error in the process, are stored in the control device 10. In this case, if no identity, integrity and/or plausibility of the redundant data transferred by means of data streaming is present, the control device 10 initiates a safety shutdown of the laser source 2, which brings about a termination of the operation of the laser processing machine 1.

The redundant data are recorded and stored, with the stored redundant data being assigned to workpieces processed by means of the laser processing machine 1. Each workpiece is assigned redundant data records of process variables, which are created during the processing of the corresponding workpiece. The material and the properties of the workpieces, for instance the thickness, are assigned to the redundant data, i.e. the redundant data are workpiece related. As a result, the received redundant data are available for each processed workpiece and can be retrieved in subsequent processing procedures. Recorded redundant data of process variables for which error-free processing is carried out can be reused for identical or similar workpieces. Equally, recorded redundant data of process variables for which inadequate processing occurs can be sorted out and no longer used. For instance, when processing an identical workpiece to a workpiece processed without errors, it is possible to set the laser power of the laser source 2, position data of the process optical unit 5, the position of the robot 16 for displacing the laser scanner and further process variables or parameters of the laser processing machine 1 accordingly. Hence, quality data storage can be performed with the redundant data, with the stored redundant data or the assessed redundant data being used further in the laser processing machine 1 and during the laser processing method to set process variables or parameters on the laser processing machine 1. The aforementioned features represent a quality assurance for the laser processing machine 1 and the laser processing method. Further, the recorded redundant data can be compared with reference data such that it is established whether the redundant data of the process variables are within a variable range categorized as safe. If the redundant data are outside of a safe variable range in this example, then it is possible to implement an emergency shutdown of the laser processing machine 1.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Laser processing machine
2 Laser source
3 Laser light cable
4 Laser controller
5 Process optical unit
6 Camera device
10 Control device
11 Processor unit
12 Process logging unit
13 First monitoring unit
14 Second monitoring unit
15 User interface
16 Robot
18 Processing head
20 Machine

1. A method for controlling a laser processing machine, the method comprising:
providing the laser processing machine, the laser processing machine comprising a laser source, a process optical unit, and a control device;
creating redundant data of the laser source and of the process optical unit;
transferring the redundant data of the laser source and of the process optical unit to the control device by data streaming; and
comparing the redundant data of the laser source and of the process optical unit.

2. The method according to claim 1, wherein the comparing the redundant data of the laser source and of the process optical unit comprises:
comparing the redundant data of the laser source and of the process optical unit with regard to identity, plausibility and/or integrity.

3. The method according to claim 1, wherein the data streaming is implemented via optical fibre connections, electric line connections, or wireless connections.

4. The method according to claim 1, further comprising:
creating redundant data with regard to a laser power of the laser source, and/or a thermal profile at a workpiece to be processed,
transferring the redundant data with regard to the laser power of the laser source and/or the thermal profile to the control device, and
monitoring the redundant data with regard to the laser power of the laser source and/or the thermal profile in the control device.

5. The method according to claim 1, wherein:
the laser processing machine further comprises a camera device, an OCT device, a pyrometer, and/or a spectrometer;
the method further comprising:
creating redundant data of the camera device, the OCT device, the pyrometer, and/or the spectrometer, and
transferring the redundant data of the camera device, the OCT device, the pyrometer, and/or the spectrometer to the control device.

6. The method according to claim 1, further comprising:
creating and transferring redundant data with regard to a position of a robot for displacing the process optical unit and a position of a workpiece.

7. The method according to claim 1, further comprising: triggering a safety shutdown of the laser source if the comparison of the redundant data of the laser source and of the process optical unit does not yield an identity of the redundant data or if the compared redundant data exceed an error threshold.

8. The method according to claim 1, further comprising:
recording and storing the redundant data of the laser source and of the process optical unit; and
assigning the stored redundant data to workpieces processed by the laser processing machine.

9. A laser processing machine comprising:
a laser source,
a process optical unit, and
a control device,
wherein the laser processing machine is configured to transfer redundant data of the laser source and of the process optical unit to the control device by data streaming, and the control device is configured to receive, by the data streaming, and compare the redundant data of the laser source and of the process optical unit.

10. The laser processing machine according to claim 9, wherein the laser processing machine is further configured to transfer redundant data with regard to a laser power of the laser source, data of the process optical unit, and/or a thermal profile at a workpiece to be processed to the control device by the data streaming.

11. The laser processing machine according to claim 9, wherein the laser processing machine comprises a camera device, an OCT device, and/or a spectrometer, and the laser processing machine is configured to transfer redundant data of the camera device, of the OCT device, or of the spectrometer to the control device by the data streaming.

12. The laser processing machine according to claim 9, wherein the control device is configured to process the redundant data in real time.

13. The laser processing machine according to claim 9, wherein the control device comprises a data stream management system.

14. The maser processing machine according to claim 11, wherein the camera device, the OCT device, and/or the spectrometer are comprised by a processing head of the laser processing machine.

15. A non-transitory computer-readable medium having program code stored thereon, the program code, when executed by a computer processor, causing performance of the method according to claim 1.
